(19) United States
(12) Patent Application Publication
(10) Pub. No.: US 2007/0147409 A1
(43) Pub. Date: Jun. 28, 2007

(54) Optimized method for multiplexing digital data

(75) Inventors: Jarno Kallio, Turku (FI); Jani Vare, Kaarina (FI)

Correspondence Address: BANNER & WITCOFF, LTD., 1100 13th STREET, N.W., SUITE 1200, WASHINGTON, DC, 20005-4051, US

(73) Assignee: Nokia Corporation, Espoo (FI)

(21) Appl. No.: 11/313,832

(22) Filed: Dec. 22, 2005

(51) Int. Cl. H04L 12/28; H04J 3/00

(52) U.S. Cl. 370/431; 370/345

(57) ABSTRACT

Provided are apparatuses and methods for identifying unused bandwidth in portions of a time slice frame that are allocated to carrying elementary service burst data and related overhead data, and using that unused bandwidth for the transmission of additional data. The unused portions may be aggregated and subdivided into unused time slice frames, which may be further subdivided into additional channels for use by different services.

### TECHNICAL FIELD

The present application is generally directed towards the transmission of digital data. More specifically, the application includes features relating to the identification of unused portions of a time slice frame, and the re-use of those portions to transmit additional data. Some related features include methods and apparatuses for allocating that additional unused portion.

### BACKGROUND

Mobile electronic devices are becoming more and more prevalent, with providers offering customers more and more features. One such feature is the transmission of digital video data, such as video mail, movies, television shows, video games, and the like. A prior standard for the transmission of digital video data, known as DVB-T (established by the European Telecommunication Standards Institute, or ETSI), had been established for the general transmission of video data in a digital network, but that standard had its drawbacks when applied in a mobile device. In particular, the DVB-T standard placed a greater power drain on the mobile device, shortening its battery life.

The reason for this power drain lay in the multiplexing of the data in the DVB-T standard. In that standard, data for multiple different elementary services (ES) were closely multiplexed together, thereby requiring receiving mobile devices to have their receiving circuitry turned on continuously during use. This continuous use of the circuitry drained battery power.

To address this, the ETSI has since developed a new standard, known as DVB-H, that overcomes this drawback by consolidating transmissions of ES streams into larger time slices, so that individual mobile devices can turn their reception circuitry on during a desired time slice, and off during other undesired time slices. The time slices are often used for the transmission of real-time data, and are periodic in nature (e.g., each slice may be a fixed period of time, such as 200 ms).

Due to the variable bandwidth nature of video (different amounts of bandwidth are needed at different points in the program), time slice periods are often defined with a worst-case scenario in mind—a period large enough to carry the maximum bit rate transmissions anticipated. At times when the video does not need the entire time slice period, the DVB-H standard contemplates filling the remainder of the time slice with NULL, or unused, packets that are essentially ignored by the receiver.

It would be an advance in the art to put these NULL portions of a time slice period to good use.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In some aspects, a method may include the allocation of first and second portions of a first time slice frame, where the first portion is allocated to a plurality of elementary services to be carried in said time slice frame, and the second portion is allocated to overhead data associated with the elementary services. Unused portions of these allocated portions may be identified, and used to carry additional data.

The unused portions may be aggregated, and then subdivided to form additional time slice frames using the unused portions. These additional time slice frames, formed from unused portions of the original frame, may carry non-real time data in portions of a frame allocated for the transmission of real-time data. These unused portion frames may be further divided into channels to carry data for different services, and the various channels may have static time intervals assigned to them, such that data for services supported by the channels appears at the same time in each received unused time slice frame.

In some aspects, these channels may include time slice interval data, which may be static, to identify the next time a receiver should tune in to receive data for a particular service supported by the aggregated, allocated, unused portion frames.

A receiver, such as a mobile terminal, may be configured to receive the time slice frame having this allocated data and the data in the aggregated, unused allocated portions of the time slice frame, and identify the data for the various services supported.

These and other aspects will be described in greater detail below.

### BRIEF DESCRIPTION OF THE DRAWINGS

A more complete understanding of the features described herein and the advantages thereof may be acquired by referring to the following description in consideration of the accompanying drawings, in which like reference numbers indicate like features, and wherein:

FIG. 1 illustrates a suitable digital broadband broadcast system in which one or more illustrative features described herein may be implemented.

FIG. 2 illustrates a suitable digital broadcast transmitter in which one or more illustrative features described herein may be implemented.

FIG. 3 illustrates a suitable mobile terminal in which one or more illustrative features described herein may be implemented.

FIG. 4 illustrates an example allocation of transmission bandwidth in a time slice frame.

FIG. 5 illustrates an example use of allocated portions of bandwidth in a time slice frame.

FIG. 6 illustrates an example aggregation of unused bandwidth in the time slice frame shown in FIG. 5.

FIG. 7 illustrates an example process for aggregating and using previously unused bandwidth portions of a time slice frame.

FIG. 8 illustrates an example sequence of aggregated unused space across several unused time slice frames.

FIG. 9 illustrates an example of an unused time slice frame divided into a plurality of independent channels for the transmission of additional data.

### DETAILED DESCRIPTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

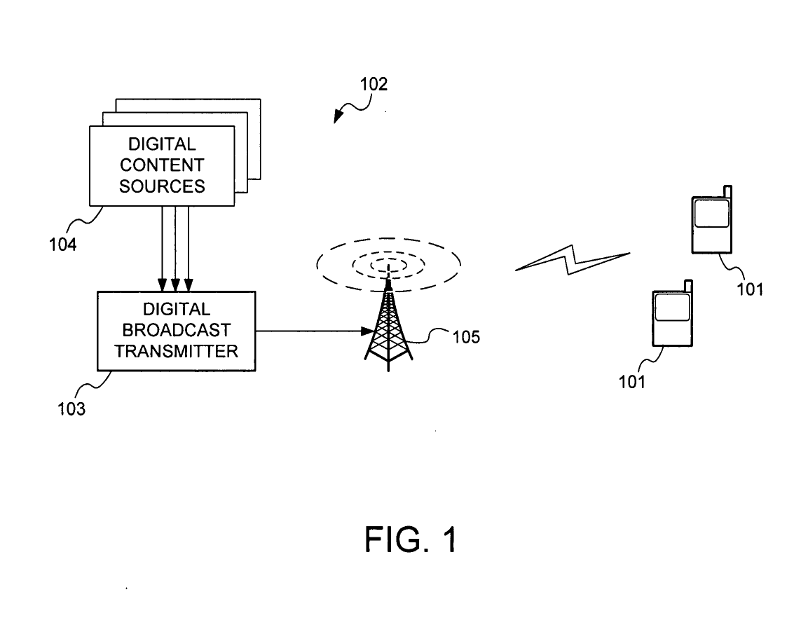

FIG. 1 illustrates a suitable digital broadband broadcast system 102 in which one or more features described herein may be implemented. Systems such as the one illustrated here may utilize a digital broadband broadcast technology, for example Digital Video Broadcast-Handheld (DVB-H). Examples of other digital broadcast standards which digital broadband broadcast system 102 may utilize include Digital Video Broadcast-Terrestrial (DVB-T), Integrated Services Digital Broadcasting-Terrestrial (ISDB-T), Advanced Television Systems Committee (ATSC) Data Broadcast Standard, Digital Multimedia Broadcast-Terrestrial (DMB-T), Terrestrial Digital Multimedia Broadcasting (T-DMB), Forward Link Only (FLO), Digital Audio Broadcasting (DAB), and Digital Radio Mondiale (DRM). Other digital broadcasting standards and techniques, now known or later developed, may also be used.

Digital content may be created and/or provided by digital content sources 104 and may include video signals, audio signals, data, and so forth. Digital content sources 104 may provide content to digital broadcast transmitter 103 in the form of digital packets, e.g., Internet Protocol (IP) packets. A group of related IP packets sharing a certain unique IP address is sometimes described as an IP stream. Digital broadcast transmitter 103 may receive, process, and forward for transmission multiple IP streams from multiple digital content sources 104. The processed digital content may then be passed to digital broadcast tower 105 (or other physical transmission implements) for wireless transmission. Ultimately, mobile terminals 101 may selectively receive and consume digital content originating with digital content sources 104. It should be understood that mobile terminals 101 may be configured, through software, firmware and/or hardware circuitry, to receive, identify and extract the various portions of information addressed further below. This may be accomplished using any desired configuration, in accordance with the data format and structure described below.

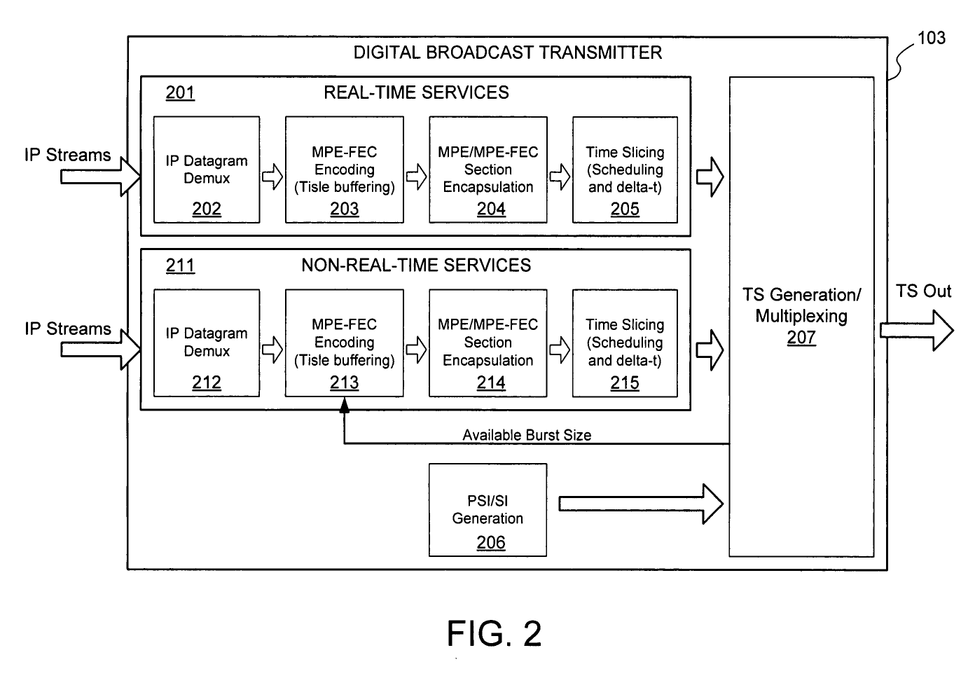

FIG. 2 illustrates a suitable digital broadcast transmitter 103 in which one or more features described herein may be implemented. Such a device may comprise an IP encapsulator, and may be comprised of hardware circuitry, firmware, software and/or any combination as desired. For example, the functional blocks shown in the figures may represent software functions on a programmable processor, as embodied in computer-readable instructions for the processor, and stored on one or more computer-readable media (e.g., disks, memories, compact disks, etc.). The functional blocks depicted in FIG. 2 present merely one possible embodiment of digital broadcast transmitter 103. Other embodiments may separate or rearrange functionality depicted. IP streams delivering content to digital broadcast transmitter 103 include both real-time services and non-real-time services. Real-time services may include content which should be delivered in a time-sensitive fashion, such as live news programs, streaming video, etc. Non-real-time services may include content which is time-insensitive, or at least less time-sensitive, such as file downloads. A service represents one or more IP streams carrying related content (e.g., a video stream coupled with its associated audio stream). Real-time services may include video or audio, or any such streams of content which rely on timely and continuous delivery. Non-real-time services may include anything for which timely and continuous delivery is less important, e.g., the downloading of a data file. IP streams for different types of services may be separated into two or more parallel pipelines 201, 211 within transmitter 103 for separate processing. Alternative embodiments may allow the scheduled sharing of different types of IP streams within the same pipeline.

The IP datagram demux block 202, 212 receives desired IP streams and divides those IP streams into elementary streams. Each elementary stream is written to a separate output. One elementary stream can contain one or more IP streams. The IP streams for each elementary stream are delivered to the Multi-Protocol Encapsulation-Forward Error Correction (MPE-FEC) encoding block 203, 213, where they are written into an application data table. Each elementary stream may be written into its own table. Once the application data table is full (or if an amount of time has passed such that another frame is needed, such as the delta-t period discussed below) the encoding block acts. If MPE-FEC is enabled, the block calculates Reed Solomon (RS) parity bytes and inserts them into an RS data table. Both data tables together, forming one MPE-FEC frame, are forwarded to the next functional block. If MPE-FEC is not enabled, then the block does not perform RS calculations, and merely buffers the IP streams for time-slice forming.

In DVB-H transmission systems, by sharing memory between the time slice buffer and the MPE-FEC RS code, a memory savings (up to 2048 kbits) may be achieved. Hence one Tisle, or time slice, burst is the same as one MPE-FEC frame. The word Tisle is intended to refer to time slicing of digital content as used, for example, by the DVB-H standard. A Tisle slot represents one time-sliced burst of digital content. A Tisle frame represents a collection of Tisle slots which repeat from frame to frame.

The MPE/MPE-FEC section encapsulation blocks 204, 214 encapsulate the payload from the previous block into a section and forms a section header. The payload is an IP datagram for a MPE section, and an RS column for a MPE-FEC section. All real-time parameters needed for each section, except for delta-t (explained below) and CRC-32, are inserted by block 204,214. Section header values, including address, table_boundary, and frame_boundary are inserted into the MPE and MPE-FEC sections. Additionally, MPE-FEC-specific header values are inserted into the section, including padding_columns, last_section_number, and section_number. The sections are then forwarded to the time slicing block 205, 215, where delta-t is calculated and inserted into section headers. Time slicing 205, 215 also calculates Cyclic Redundancy Check (CRC-32) values which are inserted into the sections as well.

Time slicing involves the transmitting of content in high-bandwidth bursts rather than in lower-bandwidth constant streams. As such, receivers of transmissions should be able to know when the next burst will be arriving, and hence delta-t is calculated to inform receivers when the following burst is to be expected. In this fashion, low power receivers are able to receive content in bursts and power down their radios in between transmissions. Differing content can be scheduled in interspersed intervals, allowing a receiver to turn on and off its radio only when content of interest is expected. A Tisle frame represents a series of time-sliced bursts sent in sequence. A Tisle slot is the spot that one burst takes within a Tisle frame. Content transmitted within a particular slot of a first frame will be broadcast in the same slot in a subsequent second frame.

The Transport Stream (TS) generation & multiplexing block 207 fragments incoming time-sliced sections into the payload of TS packet(s) and generates a header for each TS packet. The Moving Pictures Experts Group Transport Stream (MPEG TS) standard may be used to form the TS packets. The functional block also integrates sections from real-time services and non-real-time services. Finally, the time sliced sections and program specific information and signaling information (PSI/SI) from the PSI/SI generation block 206 are multiplexed into one output TS having a fixed data rate. Certain embodiments may incorporate the use of available burst size information from the TS generation & multiplexing block 207 into the MPE-FEC encoding process for non-real-time services.

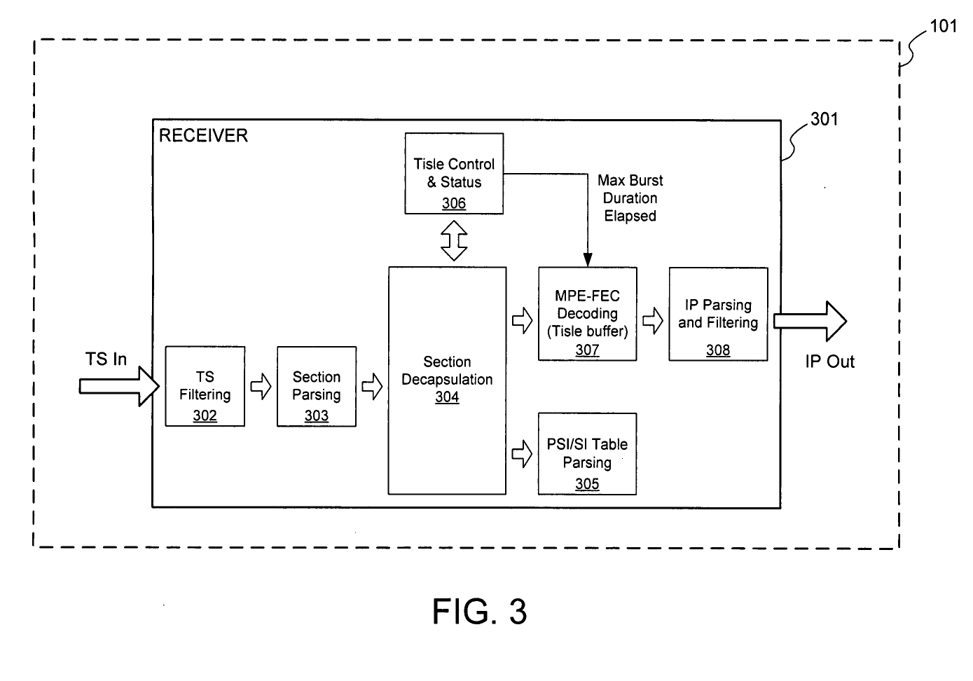

FIG. 3 illustrates a suitable mobile terminal 101 in which one or more features described herein may be implemented. The various functional blocks may be software, firmware, hardware, or any combination configured to perform the functions. This functionality may be performed by a receiver/mobile terminal microprocessor, which may execute instructions for the functions that are stored in a computer-readable medium, such as one or more memories, disks, compact disks, etc. Although one particular design is provided, functional blocks provided here may be combined, rearranged, separated, or even skipped.

An incoming signal is received by mobile terminal 101 and passed to receiver 301 as a transport stream (TS). The TS filtering block 302 receives the incoming TS in its entirety and, according to program identifiers (PIDs) assigned to TS packets, passes on only those TS packets belonging to desired content or elementary stream(s). Section parsing 303 decapsulates the payload of the TS packets and re-forms sections. The section decapsulation block 304 extracts real-time parameters and the payloads of each section. Based on the type of section (MPE/MPE-FEC or PSI/SI), it sends the section payloads and some real-time parameters to either the MPE/MPE-FEC decoding block 307 or PSI/SI table parsing block 305. The decapsulation block 304 may also send real-time parameters to the Tisle control and status block 306.

The Tisle control and status block 306 is responsible for switching off receiver 301 after a particular burst is fully received, and again switching the receiver back on before the next burst is about to be received. It also signals the MPE/MPE-FEC decoding block 307 when the time of maximum burst duration has elapsed. This signaling may be needed so that the decoding block knows to start decoding in the case where the tail end of a burst is lost.

MPE/MPE-FEC decoding block 307 writes section payloads into an MPE-FEC frame according to address information (as determined from the real-time parameters) and decodes the whole frame row by row. The decoder can be either an erasure or non-erasure decoder. Erasure info can be obtained from the section CRC-32 or, if the erroneous TS packets are passed forward, from the transport error indicator located in the header of the TS packet. If the MPE-FEC is not used, then this block may simply work as a time-slicing buffer storing one burst at a time.

IP parsing and filtering block 308 receives a whole MPE-FEC frame (or time-sliced burst). This filtering block goes through the corrected data areas in the frame to detect IP datagrams that were originally erroneous but were corrected by the decoder. It then only passes on IP datagrams having a desired IP address. PSI/SI table parsing 305 parses PSI/SI tables from among the sections and delivers signaling information to other portions of mobile terminal 101.

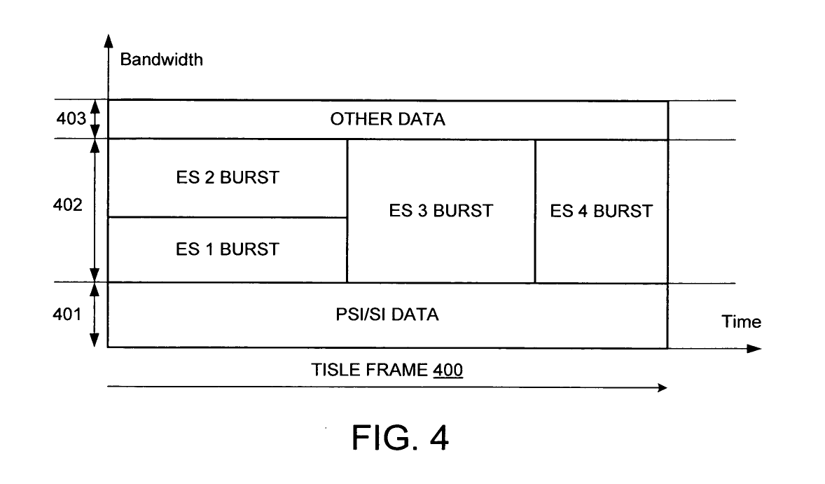

FIG. 4 illustrates an example of how a Tisle 400 may be defined. The Tisle 400 may have a predefined duration, such as 200 ms, so that after receiving one burst of data for a particular ES, the receiver knows how long to wait until the next ES burst is expected (this can be identified using the delta-t information). Until that next burst, the receiver can power down its receiving circuitry, thereby realizing the power savings achieved using DVB-H.

The data or bandwidth allocation within a Tisle 400 may include one portion 401 for PSI/SI information, or another type of overhead information associated with services carried in the Tisle 400. These types of overhead information may be viewed as being transmitted continuously, and may be used as a “roadmap” through the data stream. PSI tables may be generated according to the MPEG format, and may include a program association table (PAT—identifying services found in a transport stream); a program map table (PMT—identifying elementary streams located within a given service); a network information table (NIT—identifying information used for tuning to a particular stream); and a conditional access table (CAT—identifying conditional access systems applicable to one or more portions of the transport stream). SI tables may be generated according to the DVB standards, and may include a network information table (NIT—identifying tuning information for services); a bouquet association table (BAT—information linking multiple services on different transport streams together to allow the user to treat the services as if they were all part of a single transport stream); event information tables (EIT—listing schedules of events being transmitted); and other types of data.

The Tisle 400 may also include a portion 402 reserved for real-time burst service, which contains the actual data, such as video information, digital audio, etc., for a particular elementary stream ES, transport stream, and/or other service supported by the Tisle 400. The real-time burst portion may be divided into a number of data slots for different ES's, where each slot appears in each Tisle 400, and the delta-t value for the various slots indicates to the receivers when data for that slot's ES will be available.

Tisle 400 may also include a portion 403 reserved for the transmission of other data. This reserved portion allows the Tisle 400 to carry a guaranteed amount of real-time or non-real-time data used for a variety of purposes. The possible unused capacity from this reservation can also be used to carry other useful data, and the various portions of the tisle frames and unused portions may be independent from one another in terms of the data they carry and/or the services they support.

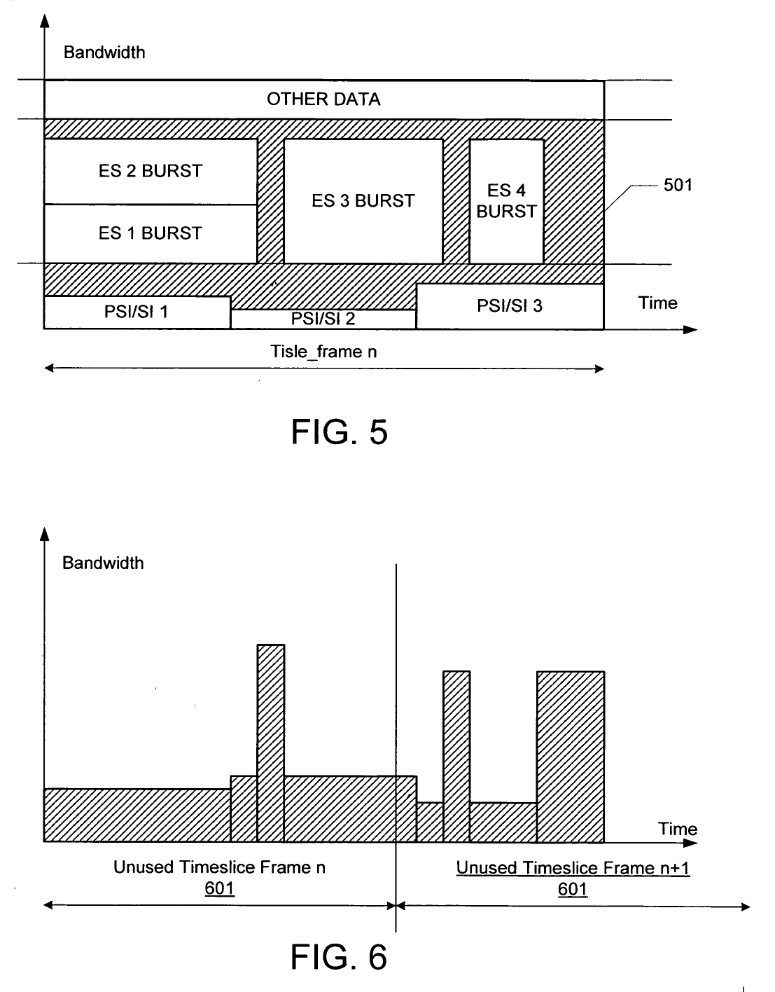

The allocations and reservations shown in FIG. 4 represent maximum values. For example, they identify the maximum amount of data that a particular ES or PSI/SI set or other static reservations may use during a given Tisle 400. The various ES's, however, often do not need their full allocation during a given Tisle. FIG. 5 illustrates an example of how these allocations may actually be used (or unused, as the case may be). As shown in FIG. 5, the actual ES's and/or PSI/SI data being sent at a given moment might leave unused bandwidth (e.g., periods of time during the transmission of a Tisle that are not needed for the transmission of ES data or PSI/SI data), shown in the figure as shaded portions 501.

Aggregating all of this unused bandwidth shows, in FIG. 6, that a usable amount of bandwidth is available for the transmission of other useful data. As will be described below, this unused bandwidth may be aggregated, and then divided into one or more unused time slice frames 601, into which data of various types may be inserted.

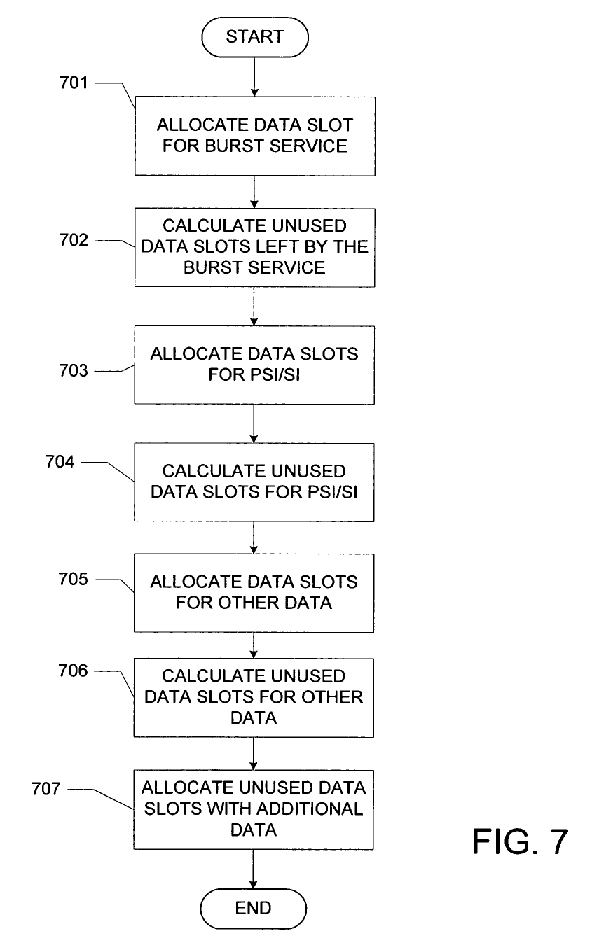

FIG. 7 illustrates an example process of how this unused bandwidth may be obtained and allocated. In step 701, the transmitter 103 may first allocate bandwidth portions for the burst service carried in the Tisle 400. This may include, for example, identifying burst service slots in which data for different ES's may be carried, and the calculation of delta-t values for the various slots indicating the amount of time expected to pass before that slot appears again in a subsequent Tisle frame 400.

When the burst allocation is known, the transmitter 103 may then, in step 702, dynamically determine the amount of actual burst data that will be carried in a particular instance of the Tisle frame 400, and calculate the amount of unused transmission capability in the burst section. For example, the TS Generation and Multiplexing function 207 may compare the current ES bursts with the allocation given to the burst service in step 701. The unused amount is then identified (e.g., the times and bandwidth portions in the Tisle that have been allocated to the burst service data, but not currently used for the current Tisle), and the use of these unused portions is described further below.

In step 703, the overhead portion (PSI/SI 401) of the Tisle frame 400 is allocated. As noted above, this allocation may include the identification of separate divisions or slots corresponding to the different ES slots carried in the burst data 402. The allocation may also identify the locations (e.g., timing) of the individual contents of the PSI/SI information, such as individual tables.

Then, in step 704, the transmitter 103 may calculate the unused portion of the overhead portion 401, much in the same way as done with the burst portion. This calculation may involve consulting the unused bitrate of static reservations (e.g., for the PSI/SI channel). Similarly, in step 705, the transmitter 103 may allocate other data to portions of the frame, and in step 706, the transmitter may calculate the unused portion of those other portions of the frame.

In step 707, when the unused amounts (e.g., unused data slots) in the overhead portion 401, burst portion 402, and other portion 403 are known, the transmitter 103 may aggregate this unused transmission capability and allocate it to the transmission of additional data. Since the unused portions may come from a variety of locations within the Tisle 400 (e.g., some from an unused portion of a horizontally-divided ES 2 burst (shown in FIG. 5) and some from an unused portion of the overhead portion 401), the transmitter may need to generate additional overhead information mapping this unused space to a single contiguous aggregated space. This overhead information may identify unused portions by time within the Tisle and/or length, with additional information identifying how the unused portions may be combined to create the contiguous frame 601 shown in FIG. 6 (e.g., length information and an identification of the next location). For example, the transmitter 103 may create a separate table containing an entry for each unused portion in the Tisle, where each entry identifies a start time within the Tisle, duration, and a pointer to the next unused portion within the Tisle.

As illustrated in FIG. 6, the unused bandwidth may be viewed as unused timeslice frames 601, where the frames may have a duration or period equal to the Tisle frame 400 containing the available unused data. In viewing the frames this way, the unused timeslice frames 601 may be assigned a period value (e.g., delta-t), but the actual bitrate supported in each frame 601 will vary depending on the amount of unused space that happens to be available at any moment in time. Accordingly, the unused timeslice frames 601 may be conveniently used by applications that are not real-time, such as best-effort file transfer applications, file sharing applications on the Internet, other non-real-time IP data transmissions, etc.

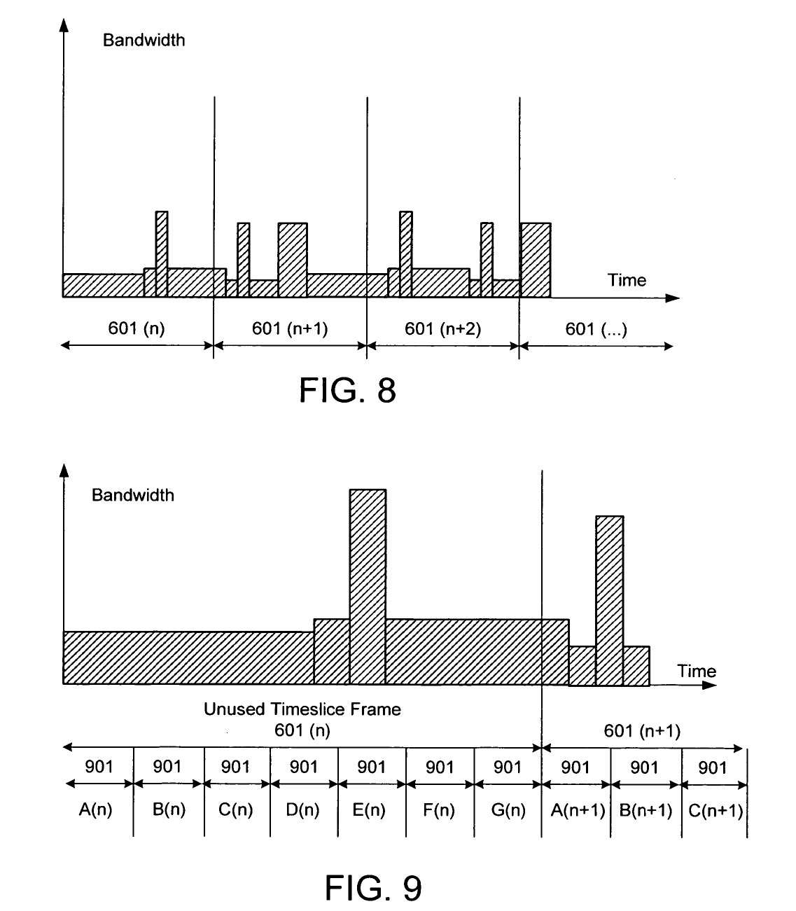

FIG. 8 illustrates an example division of the aggregated available bandwidth. Timeslice frames 601 may have the same time duration as the Tisle frame 400 that provided the unused space. Alternatively, the frames 601 may have a different length from the Tisles 400. By using a predefined time duration (e.g., defined by the TS Generation Multiplexing function 702 during creation of the instant Tisle), a receiving device may know in advance when to tune in to receive its relevant data, consistent with the battery conservation aims of DVB-H.

The individual unused timeslice frames 601 may be further divided into sub-channels, which can be used to support multiple distinct ES's, applications and devices. As shown in FIG. 9, the unused timeslice 601 may be divided into a plurality of unused service bursts 901 that can be used to support separate applications and/or devices. In the FIG. 9 example, the unused timeslice 601 is divided into seven different channels 901 (A-G), and timeslice 601 for frame (n) may include a separate burst (n) for each of the channels A-G. The subsequent timeslice 601 (n+1) may then include the subsequent burst (n+1) for the same channels. Greater or fewer channels may also be defined, depending on the number of services to be supported using the unused timeslice 601.

Each burst 901 may be of a fixed period/duration, and may contain substantive data being transferred, such as portions of a file being transferred. The burst 901 may also include its own delta-t value (e.g., a delta-t time value that may indicate the next time a particular burst 901 is available), to allow receivers to know when to expect data for the particular burst 901. For example, the burst A(n) may contain information identifying the delta-t value for the time that will pass before the next burst A(n+1) is expected to be sent for the given channel. These delta-t values may, in some instances, be a static time slice interval where the values are identical in every burst, so that the bursts always appear at the same locations in the tisle.

With these divisions, the timing of the various service bursts 901 within the Tisle 400 may be reliably known to the receivers. Of course, the actual amount of data that can be transmitted in any given service burst 901 will vary depending on the amount of unused space in the various Tisles 400 (although the theoretical maximum will be the entire bandwidth of the allocated portion(s) in Tisle 400).

The processes described herein are conceptual in nature for ease of explanation, but need not be implemented in this same order described. Additionally, the various functions and process steps described above may be implemented by one or more processors (e.g., microprocessor in transmission station 103 or receiver), and stored on one or more computer-readable media in the form of computer-executable instructions.

The present application includes any novel feature or combination of features disclosed herein either explicitly or any generalization thereof. While the features have been described with respect to specific examples, those skilled in the art will appreciate that there are numerous variations and permutations of the above described systems and techniques. Thus, the spirit and scope of the application should be construed broadly as set forth in the appended claims.

We claim:

1. A digital broadcast method, comprising the steps of:
allocating first and second portions of a first time slice frame, wherein said first portion is allocated to a plurality of elementary services to be carried in said time slice frame, and said second portion is allocated to overhead data associated with said elementary services;
identifying one or more portions of said first portion allocated to said elementary services, and one or more portions of said second portion allocated to overhead data, that would be unused in filling a current instance of said time slice frame with overhead and elementary service data to be transmitted;
aggregating said identified portions of said time slice frame; and
using said aggregated identified portions to transmit additional data in said time slice frame.

2. The method of claim 1, wherein said allocating said first portion further includes the step of identifying a fixed location in said first time slice frame for a first elementary service, wherein data for said first elementary service appears at said fixed location in a plurality of sequential time slice frames transmitted in said method.

3. The method of claim 2, wherein said first portion is further allocated with a static time slice interval identifying the next time data for said elementary service will appear in a subsequent time slice frame.

4. The method of claim 1, wherein said step of using further includes the step of dividing said aggregated portions into a plurality of unused time slice frames.

5. The method of claim 4, wherein said unused time slice frames have a duration equal in length to a duration of said first time slice frame.

6. The method of claim 4, wherein said step of using further includes the step of dividing one of unused time slice frames into a plurality of data channels and using said channels to transmit data for a plurality of services.

7. The method of claim 6, wherein said services in said channels of said unused time slice frames are different from said elementary services.

8. The method of claim 6, wherein said data channels are assigned a static interval, and repeat in appearance in subsequent instances of said unused time slice frame.

9. The method of claim 6, wherein said data channels are assigned a variable interval, and repeat in appearance in subsequent instances of said unused time slice frame.

10. A mobile terminal receiver capable of performing the following steps:
receiving a time slice frame via wireless transmission;
identifying a first amount of service data for a plurality of services allocated to a first portion of said time slice frame;
identifying a second amount of overhead data for said plurality of services, said overhead data allocated to a second portion of said time slice frame;
identifying an additional amount of data in portions of said time slice frame that are allocated to, but unused by, said first amount of service data, and an additional amount of data in portions of said time slice frame that are allocated to, but unused by, said second amount of service data.

11. The mobile terminal receiver of claim 10, further capable of identifying a fixed location in said first portion containing data for a first elementary service.

12. The mobile terminal of claim 11, further capable of identifying, in said time slice frame, a static time slice interval identifying the next time data for said elementary service will appear in a subsequent time slice frame.

13. The mobile terminal of claim 10, further capable of identifying a plurality of frames within said additional amounts of data.

14. The mobile terminal of claim 10, wherein said additional amounts of data are used by services on said mobile terminal that are different from said plurality of services.

15. A computer-readable medium, containing computer-executable instructions for performing a digital broadcast method, comprising the steps of:
allocating first and second portions of a first time slice frame, wherein said first portion is allocated to a plurality of elementary services to be carried in said time slice frame, and said second portion is allocated to overhead data associated with said elementary services;
identifying one or more portions of said first portion allocated to said elementary services, and one or more portions of said second portion allocated to overhead data, that would be unused in filling a current instance of said time slice frame with overhead and elementary service data to be transmitted;
aggregating said identified portions of said time slice frame; and
using said aggregated identified portions to transmit additional data in said time slice frame.

16. The computer-readable medium of claim 15, wherein said allocating said first portion further includes the step of identifying a fixed location in said first time slice frame for a first elementary service, wherein data for said first elementary service appears at said fixed location in a plurality of sequential time slice frames transmitted in said method.

17. The computer-readable medium of claim 16, wherein said first portion is further allocated with a variable but determinable time slice interval identifying the next time data for said elementary service will appear in a subsequent time slice frame.

18. The computer-readable medium of claim 17, wherein said first portion is further allocated with a static time slice interval identifying the next time data for said elementary service will appear in a subsequent time slice frame.

19. The computer-readable medium of claim 16, wherein said step of using further includes the step of dividing said aggregated portions into a plurality of unused time slice frames.

20. The computer-readable medium of claim 19, wherein said unused time slice frames have a duration equal in length to a duration of said first time slice frame.

21. The computer-readable medium of claim 19, wherein said step of using further includes the step of dividing one of unused time slice frames into a plurality of data channels and using said channels to transmit data for a plurality of services.

22. The computer-readable medium of claim 21, wherein said services in said channels of said unused time slice frames are different from said elementary services.

23. The computer-readable medium of claim 21, wherein said data channels are assigned a static interval, and repeat in appearance in subsequent instances of said unused time slice frame.

24. The computer-readable medium of claim 21, wherein said data channels are assigned a variable but determinable interval, and repeat in appearance in subsequent instances of said unused time slice frame.

25. A digital broadcast method, comprising the steps of:
allocating first and second portions of a first time slice frame, wherein said first portion is allocated to a plurality of elementary services to be carried in said time slice frame, and said second portion is allocated to overhead data associated with said elementary services;
identifying one or more portions of said first portion allocated to said elementary services, and one or more portions of said second portion allocated to overhead data, that would be unused in filling a current instance of said time slice frame with overhead and elementary service data to be transmitted;
aggregating said identified portions of said time slice frame;
dividing said aggregated portions into a plurality of unused time slice frames; and
inserting additional data into said unused time slice frames, said additional data in each unused time slice frame containing data for a different elementary service, wherein said first portion is allocated to a plurality of real-time elementary services, and said additional data corresponds to a plurality of non-real-time services.

26. A digital data system, comprising:
(i) a transmitter capable of performing the following steps:
(a) allocating first and second portions of a first time slice frame, wherein said first portion is allocated to a plurality of elementary services to be carried in said time slice frame, and said second portion is allocated to overhead data associated with said elementary services;
(b) identifying one or more portions of said first portion allocated to said elementary services, and one or more portions of said second portion allocated to overhead data, that would be unused in filling a current instance of said time slice frame with overhead and elementary service data to be transmitted;
(c) aggregating said identified portions of said time slice frame; and
(d) using said aggregated identified portions to transmit additional data in said time slice frame; and
(ii) a mobile receiver capable of performing the following steps:
(a) receiving said time slice frame via wireless transmission;
(b) extracting said elementary service and overhead data from said first and second portions in said time slice frame; and
(c) extracting said additional data from said aggregated portions of said time slice frame.

27. The system of claim 26, wherein said time slice frame is formatted according to the ETSI DVB-H standard.
